(19) United States
(12) Patent Application Publication
(10) Pub. No.: US 2004/0218037 A1
(43) Pub. Date: Nov. 4, 2004

(54) 3D display using micromirrors array

(76) Inventors: Stephen T. Kowel, Cincinnati, OH (US); Jun Yan, Cincinnati, OH (US); Hyong Jin Cho, Cincinnati, OH (US); Chong H. Ahn, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/479,738

(22) PCT Filed: May 29, 2002
(86) PCT No.: PCT/US02/16870

Related U.S. Application Data
(60) Provisional application No. 60/294,106, filed on May 29, 2001.

(51) Int. Cl. H04N 13/00

(52) U.S. Cl. 348/51; 348/42

(57) ABSTRACT

Method and apparatus incorporates relaying (22) and collecting lens (24) to gather, direct and enlarge three-dimensional light images reflected from an array of interleaved and/or plastic-based micromirrors (10).

### CROSS-REFERENCE TO RELATED APPLICATIONS

This application claims the benefit of U.S. Provisional Application No. 60/294,106 filed on May 29, 2001, the disclosure of which is hereby incorporated by reference herein in its entirety.

### FIELD OF THE INVENTION

The present invention relates to three-dimensional display systems, and more particularly to a display system that uses micromirror technologies to produce a three-dimensional image.

### BACKGROUND OF THE INVENTION

Three-dimensional display systems have great utility in the context of medical, military and entertainment applications. Such images conventionally create a perception of depth resulting from the simultaneous observation of a single image from two different vantage points. The points correspond to each of an observer's eyes. While efforts to produce such images have met with some success, many sacrifice image, color, resolution and number of views. Other display methods are incapable of displaying real-time Images, and may require numerous moving parts, expensive materials, complex program protocols and specialized image sources. Consequently, what is needed is a mechanism for producing a three-dimensional image in a manner capable of addressing problems associated with conventional image display.

### SUMMARY OF THE INVENTION

The present invention provides an improved apparatus and method for projecting a three-dimensional image in a manner that addresses above-identified problems of prior art systems. In one respect, an embodiment of the present invention provides real-time, autostereoscopic images with motion parallax by creating multiple views from different perspectives and directing these views to viewing zones. To this end, a source may project an image to a micromirror array. A collecting lens may be positioned to redirect light reflected from the micromirror array to appropriate viewing zones. Utilization of the collecting lens functions, in part, to reduce actuation requirements associated with conventional micromirror applications.

Another or the same embodiment may further incorporate a relaying lens configured to refract light to the micromirror array. Such a relaying lens acts to further reduce actuation requirements. For instance, the relaying lens may have multiple pupils configured to enlarge viewing zones. The one or more of the pupils may be obstructed in alternating fashion to facilitate creation of more viewing zones. Such a feature may minimize the need for mirror movement otherwise required by the micromirror array.

The micromirror array, itself, may be configured to realize distinct advantages. For instance, an exemplary array may include micromirrors that comprise a reflective surface that coats a plastic substrate. Such construction translates into larger arrays that can be more cheaply manufactured. Another micromirror embodiment may include interleaved micromirrors. The interleaved micromirrors may cooperate with others to form an array that effectively halves actuation requirements.

Thus, by virtue of the foregoing there is provided an improved mechanism for projecting a three-dimensional image. These and other objects and advantages of the present invention shall be made apparent in the accompanying drawings and the description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiments given below, serve to explain the principles of the invention.

FIG. 1 illustrates exemplary optical ray-tracing layouts for a micromirror array that are consistent with the principles of the present invention;

FIG. 2 illustrates another micromirror suitable for inclusion within the array of FIG. 1;

FIG. 3 is a perspective view of the micromirror of FIG. 2 taken along line 3-3; and

FIG. 4 illustrates a micromirror suitable for inclusion within the array of FIG. 1.

### DETAILED DESCRIPTION OF SPECIFIC EMBODIMENTS

The invention capitalizes on Micro-Electro-Mechanical Systems (MEMS) technology to produce a autostereoscopic three-dimensional display with motion parallax. More specifically, an array of scanning micromirrors reflects multiple image views projected from a spatial light modulator. The display directs the images into designated viewing zones. Such zones may correspond to multiple stereoscopic views, so that an observer can move his/her head along a horizontal region and perceive a desired three-dimensional sensation motion parallax as well as depth (stereopsis). The reflective nature of the micromirrors further enables full color reproduction, simplifying system design.

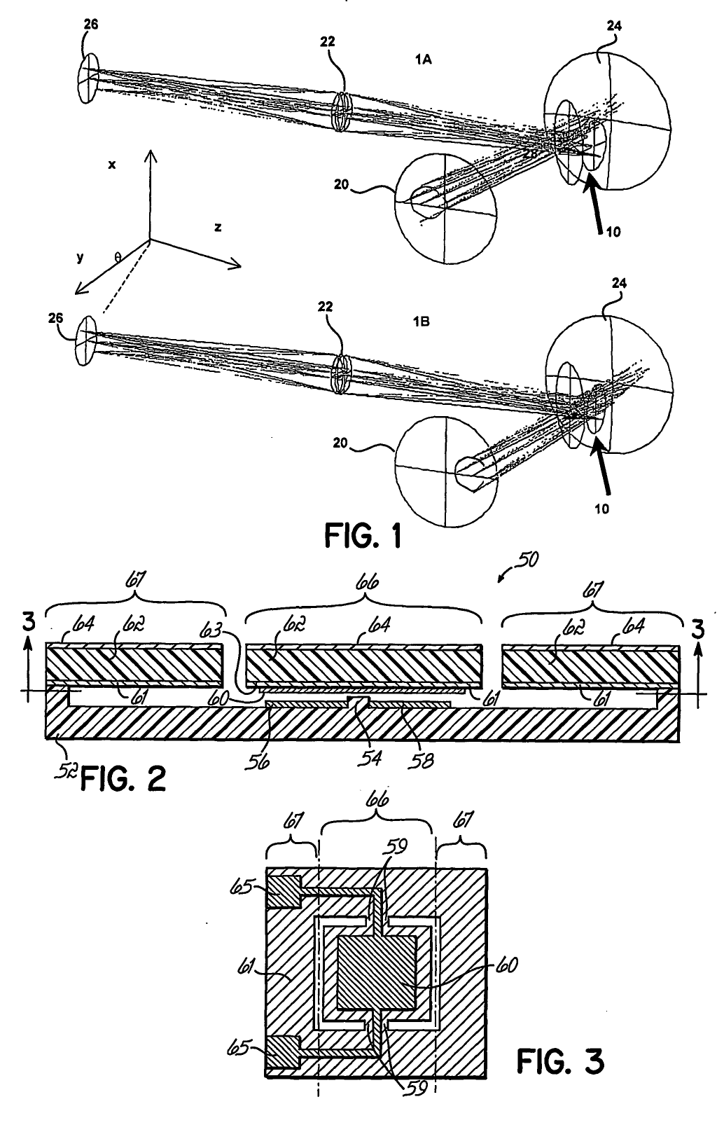

In order to achieve the desired effect, the micromirror display may incorporate several features configured to reduce mirror actuation, circuitry, cost and size requirements. Such features may include a collecting lens/mirror, a relaying lens, plastic-based micromirrors and/or interleaved micromirrors. FIGS. 1A and 1B illustrate exemplary configurations and imaging sequences for these features in the context of just two (left and right) viewing zones. Namely, a double-pupil relaying lens 22 separates and directs modulated light through a beam splitter 28 to a micromirror array 10. The beam splitter 28 redirects light reflected from the array 10 to a collecting lens 24. The collecting lens 24 focuses and redirects the light to appropriate viewing zones 20. Thus, an observer positioned at the viewing zones 20 can perceive a three-dimensional image reflected from the micromirror array 10.

Turning more specifically to FIG. 1A, an image source 26 communicates a display to the relaying lens 22. While a fast spatial light modulator (SLM) is preferred, the source 26 may be substituted with any conventional display means, such as a cathode ray tube. The relaying lens 22 may comprise an opaque lens having two openings, or pupils. Dimensions of a relaying lens consistent with the principles of the present invention may be between about six millimeters and about ten millimeters in diameter. However, it should be understood that the proffered range is merely exemplary, and may be substantially varied according to system specifications, as with all ranges stated in this disclosure.

The pupils of the relaying lens 22 allow projected light and embodied images to pass through the relaying lens 22. Significantly, the dual-pupil property of the relaying lens 22 functions to enlarge viewing zone separation. This separation decreases actuation/deflection angle requirements of the micromirrors 10. For instance, the relaying lens 22 may decrease actuation requirements by about five and one half percent in either direction. The relaying lens 22 may further provide for twice as many viewing zones 20 as a comparable, single-pupil lens. One embodiment may further incorporate shutters to close one of the respective pupils of the relaying lens 22 in alternating fashion in such a manner as to produce additional viewing zones.

As shown in FIG. 1, the relaying lens 22 may redirect light through a beam splitter 28 to a micromirror array 10. While an exemplary micromirror array 10 may consist of numerous mirror elements suspended on a substrate by mechanically compliant torsion, a suitable micromirror array 10 may comprise any device having a reflective surface. A typical micromirror of an array 10 may comprise a square reflective surface having respective lengths of about 280 micromillimeters. As such, the micromirrors' actuation is synchronized with the image source 26 in such a manner as to reflect views of the image to appropriate viewing zones. To this end, one should note that different configurations of micromirror arrays 10 can be realized in accordance with the principles of the present invention.

Another embodiment employs a plastic-based micromirror or micromirror array 10 having a plastic torsion hinge(s). As shown in FIG. 2, such a micromirror 50 includes a plastic substrate base 52 having a ridge 54 formed by known techniques, such as molding, injection or embossing. While not limited to such, suitable plastic material may comprise acrylonitrile-butadiene-styrine, polymethylmethacrylate, polyether terephthalate and/or polycarbonate. Of note, the plastic manufacture of the substrate/micromirror 50 allows it to be constructed to dimensions larger than that of conventional silicon micromirrors. For instance, an exemplary micromirror array 10 may be manufactured in excess of eight inches in diameter. Increased size can translate into larger displays and still smaller actuation requirements.

Control electrodes 56, 58 on either side of the ridge 54 may be formed by evaporation, sputtering or another known techniques, followed by photolithography and etching. The control electrodes 56, 58 use electrostatic actuation to attract and repel a mirror electrode 60 suspended above the ridge 54. That is, as electricity flows through a control electrode 56 or 58, the control electrode 56 or 58 attracts a corresponding side of the mirror electrode 60. Plastic (typically polyimide) hinges 59, best seen in the sectional view of FIG. 3, permit the mirror electrode 60 to rotate, or tilt, towards the activated control electrode 56. In one embodiment, the hinges 59 of the micromirror 50 extend in the plane of polyimide layer 61 along a direction parallel to the ridge 54.

The plastic characteristics of the hinges 59 allow them to be formed by reactive ion etching and cooperate with the ridge 54 and substrate base 52 to enable movement of the mirror electrode 60 and associated structure of the micromirror 50. An embodiment of the mirror electrode 60 as shown in FIG. 3 further includes pads 65 suited to receive and conduct electricity in accordance with the electrostatic operation of the micromirror 50. Of note, one skilled in the art will appreciate that the pads 65 may connect to wires, conductive substrate or other conventional conductive mechanisms in any known manner. Moreover, the control electrodes 56, 58 typically utilize similar pads to supply electricity to the control electrodes 56, 58, but may alternatively rely on any other known conductive convention in accordance with the principles of the present invention.

As shown in FIGS. 2 and 3, the mirror electrode 60, polyimide layer 61 and hinges 59, in turn, bond, adhere or otherwise attach to each other and/or the bottom surface 63 of a plastic substrate layer 62 and a reflective layer 64. Thus, actuation of the mirror electrode 60 ultimately functions to move the plastic substrate layer 62 and associated reflective layer 64 in a manner suited to realize desired incidence angles ranging from about 1.5 degrees to about 10.7 degrees. Of note, one skilled in the art should appreciate that the above stated range is disclosed for exemplary purposes only, and can be expanded substantially in accordance with varying system requirements and while remaining within the principles of the present invention.

In addition to superior performance, the techniques and materials associated with the manufacture and operation of the micromirror 50 and an array 10 of such devices can result in substantial manufacturing savings. Moreover, plastic construction associated with the illustrated embodiment of FIGS. 2 and 3 may enable larger displays than are possible with comparable silicon-based applications. Additionally, it should be appreciated that while micromirror 50 of FIGS. 2 and 3 includes only one actuating component 66, non-actuating components 67 could be supplanted with other micromirrors in an array 10 configuration to realize greater benefits and larger displays.

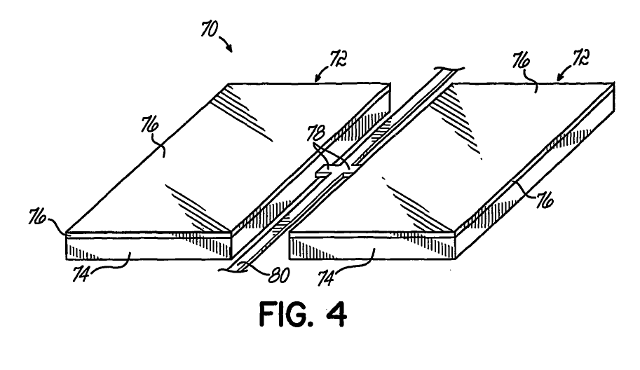

In another embodiment, each mirror structure/element of an exemplary array 10 can be configured to further minimize actuation requirements. One such configuration comprises two interleaved micromirrors. More particularly, an embodiment of a suitable interleaved structure 70 is shown in FIG. 4. The interleaved structure 70 includes two reflective portions 72. Each reflective portion typically comprises a silicon-based substrate 74 coated with a reflective layer 76 of gold or aluminum. However, one skilled in the art should recognize that the any material or combination of materials useful in realizing a comparable interleaved design may be used in accordance with the principles of the present invention. Thus, an embodiment may alternatively be manufactured using plastic materials and methods discussed in conjunction with FIGS. 2 and 3. As above, the reflective portions 72 typically rotate in a vertical plane on etched silicon hinges 78 according to known electrostatic or magnetic actuation processes. That is, the reflective portions 72 deflect downward or upward from the hinges 78 in response to an electromagnetic field selectively emanating from below the substrate 74.

In practice, the configuration of the interleaved structure 70 halves actuation requirements by doubling the availability of scanning mirrors. Thus, actuation requirements and required angles of incidence can be reduced to between about 1.5 percent to about 2.5 percent in either direction. The number of interleaved butterfly structures in an array 10 may number in the millions for a large array, with each column of the interleaved structure 70 reflecting light to different viewing zones. In similar fashion, the interleaved/butterfly structure 70 may further reduce the time required by the actuation profile in between image scans. That is, the interleaved structure 70 requires proportionately less time to achieve the requisite, smaller angles of incidence. Thus, an embodiment of the interleaved structure better accommodates high speed/streaming image applications.

Irrespective of the particular construction of the micromirror array 10 of FIG. 1, the beam splitter 28 redirects light from the micromirror array 10 to a collecting lens 24. While not limited to such, the dimensions of a positive lens comprising a typical collecting lens 24 may range from about eight inches to about ten inches in diameter. As such, the size of the collecting lens 24 can be similar to that of the micromirror array 10. Of note, while a positive lens functions adequately in the role of the collecting lens 24, another embodiment may substitute a concave mirror or other functionally equivalent refractive element in a manner consistent with the principles of the present invention.

The collecting lens 24 of FIG. 1 collects the vertical light spread by the micromirrors and steers it into a single region. In this manner, the collecting lens 24 obviates the need for conventional mechanical actuation in one dimension. For instance, the illustrated lens configuration can eliminate the need to actuate a micromirror array 10 vertically. Thus, micromirror orientation may be uniformly accomplished while the collecting lens 24 directs images to appropriate viewing zones 20. The uniformity provided by the collecting lens 24 substantially reduces complexities associated with two-dimensional array actuation. Functionally, the collecting lens 24 focuses and reduces the size of the right and left viewing zones so that their separation corresponds to around 65 mm, or the average distance between left and right human pupils. The collecting lens 24 further enlarges the view of the actual image diffracted to the viewing zones.

Of note, any of the above features may be used independently or in combination with each other as dictated by equipment, cost and performance considerations. In any case, the benefits associated with the micromirror display include the production of a three-dimensional view in such a manner that avoids complexities associated with holographic and volumetric technologies. The different perspectives of the scene are provided by scanning the individual views quickly enough that the viewer does not realize that the views are not constant. Depth is provided by providing stereo pairs to the left and right eye; motion parallax may be provided by through multiple sets of stereo-pair images. The micromirror display effectively relays all colors without modification and is compatible with a wide variety of conventional image sources. The reduced actuation requirements of the display further make it ideal for systems facing equipment cost, power and space limitations.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. An apparatus for projecting a three-dimensional image, comprising:
an image source;
a micromirror array configured to receive light projected from the image source; and
a collecting lens positioned to redirect light reflected from the micromirror array to a viewing zone.

2. The apparatus of claim 1, further comprising a relaying lens configured to refract light projected from the image source.

3. The apparatus of claim 2, wherein the relaying lens refracts the light to the micromirror array.

4. The apparatus of claim 2, wherein the relaying lens has a plurality of pupils.

5. The apparatus of claim 2, wherein at least one pupil of the plurality of pupils is obstructed.

6. The apparatus of claim 1, wherein at least one micromirror of the array is interleaved.

7. The apparatus of claim 1, wherein at least one micromirror of the array includes a plastic component selected from a group consisting of: a hinge, a base, a substrate layer and some combination thereof.

8. An apparatus for projecting a three-dimensional image, comprising:
an image source; and
at least one interleaved micromirror configured to receive and redirect light projected from the image source to a viewing zone.

9. The apparatus of claim 8, further comprising a collecting lens positioned to redirect light reflected from the at least one interleaved micromirror to the viewing zone.

10. The apparatus of claim 8, further comprising a relaying lens configured to refract light projected from the image source.

11. An apparatus for projecting a three-dimensional image, comprising:
an image source;
a relaying lens having multiple pupils and configured to receive light projected from the image source; and
a micromirror array configured to receive light projected from the image source.

12. The apparatus of claim 11, further comprising a collecting lens positioned to redirect light reflected from the micromirror array to the viewing zone.

13. The apparatus of claim 11, wherein at least one micromirror of the array is interleaved.

14. The apparatus of claim 11, wherein at least one micromirror of the array includes a plastic component selected from a group consisting of: a hinge, a base, a substrate layer and some combination thereof.

15. The apparatus of claim 11, wherein at least one pupil of the plurality of pupils is obstructed.

16. An apparatus for projecting a three-dimensional image, comprising:
an image source; and
at least one micromirror configured to receive and redirect light projected from the image source to a viewing zone, wherein the at least one micromirror includes a plastic layer coated with a reflective surface.

17. The apparatus of claim 16, further comprising a collecting lens positioned to redirect light reflected from the at least one micromirror to the viewing zone.

18. The apparatus of claim 16, further comprising a relaying lens configured to refract light projected from the image source.

19. The apparatus of claim 16, wherein the at least one micromirror is interleaved.

20. A method for projecting a three-dimensional image, comprising:
projecting light from an image source to a micromirror array; and
using a collecting lens to redirect light from the micromirror array to a viewing zone.

21. The method of claim 20, further comprising redirecting light projected from the image source to the micromirror array.

22. The method of claim 21, wherein redirecting light projected from the source to the micromirror array further includes using a relaying lens.

23. The method of claim 22, wherein using the relaying lens includes using a relay lens having a plurality of pupils.

24. The method of claim 23, further comprising obstructing at least one pupil of the plurality of pupils.

25. The method of claim 20, further comprising interleaving at least one micromirror of the array.

26. The method of claim 20, further comprising constructing a substrate of at least one micromirror of the micromirror array using a plastic component.

27. A method for projecting a three-dimensional image, comprising:
projecting light from an image source to a relaying lens, wherein the relaying lens has a plurality of pupils;
refracting light from the relaying lens to a micromirror array; and redirecting light from the micromirror array to a viewing zone.

28. The method according to claim 27, further comprising obstructing the light through a first pupil of the plurality of pupils.

29. The method according to claim 27, further comprising positioning a collecting lens to redirect light reflected from the micromirror array to the viewing zone.

30. The method according to claim 27, further comprising interleaving at least one micromirror of the array.

31. The method of claim 27, further comprising constructing a substrate of at least one micromirror of the array using a plastic.
